(19) United States
(12) Patent Application Publication
(10) Pub. No.: US 2010/0034464 A1
(43) Pub. Date: Feb. 11, 2010

(54) APPARATUS AND METHOD FOR TRACKING IMAGE

(75) Inventors: Satoshi Ito, Tokyo (JP); Susumu Kubota, Tokyo (JP); Tsukasa Ike, Tokyo (JP); Tatsuo Kozakaya, Kanagawa-ken (JP); Tomoyuki Takeguchi, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/535,765

(22) Filed: Aug. 5, 2009

(30) Foreign Application Priority Data
Aug. 5, 2008 (JP) 2008-202291

(51) Int. Cl. G06K 9/46; G06K 9/62

(52) U.S. Cl. 382/190; 382/224

(57) ABSTRACT

An image processing apparatus includes a classification unit configured to extract N features from an input image using pre-generated N feature extraction units and calculate confidence value which represents object-likelihood based on the extracted N features, an object detection unit configured to detect an object included in the input image based on the confidence value, a feature selection unit configured to select M feature extraction units from the N feature extraction units such that separability between the confidence value of the object and that of background thereof becomes greater than a case where the N feature extraction units are used, the M being a positive integer smaller than N, and an object tracking unit configured to extract M features from the input image and tracks the object using the M features selected by the feature selection unit.

### CROSS-REFERENCE TO RELATED APPLICATIONS

This application is entitled to claim the benefit of priority based on Japanese Patent Application No. 2008-202291, filed on Aug. 5, 2008; the entire contents of which are incorporated herein by reference.

### FIELD OF THE INVENTION

The present invention relates to an apparatus and a method for tracking an image, and more particularly, relates to an apparatus and a method which may speed up tracking of an object and improve robustness.

### DESCRIPTION OF THE BACKGROUND

JP-A 2006-209755 (KOKAI) (see page 11, FIG. 1) and L. Lu and G. D. Hager, “A Nonparametric Treatment for Location/Segmentation Based Visual Tracking,” Computer Vision and Pattern Recognition, 2007 disclose that conventional image processing apparatuses have tracked objects using classification units which separates the objects from their backgrounds in input images, adapting to the appearance changes of the objects and their background at different time. The apparatuses have generated new feature extraction units when the classification units have been updated. The features extracted by feature extraction units have not been always effective to separate the objects from their backgrounds when the objects changes temporarily (e.g., a person raises his/her hand for a quick moment) and therefore tracking may be unsuccessful.

As stated above, the conventional technologies may fail to track because the features extracted by newly generated feature extraction units have not been always effective to separate the objects from their backgrounds.

### SUMMARY OF THE INVENTION

The present invention allows high-speed and robust tracking of an object and improvement of an image processing apparatus, an image processing method and an image processing program.

An aspect of the embodiments of the invention is an image processing apparatus which comprises a classification unit configured to extract N features from an input image using pre-generated N feature extraction units and calculate confidence value which represents object-likelihood based on the extracted N features, an object detection unit configured to detect an object included in the input image based on the confidence value, a feature selection unit configured to select M feature extraction units from the N feature extraction units such that separability between the confidence value of the object and that of background thereof become greater than a case where the N feature extraction units are used, the M being a positive integer smaller than N, and an object tracking unit configured to extract M features from the input image and tracks the object using the M features selected by the feature selection unit.

### BRIEF DESCRIPTION OF THE DRAWINGS

FIG. 1 shows a block diagram of an image processing apparatus according to a first embodiment of the invention.

FIG. 2 shows a block diagram of a storage unit according to the first embodiment.

FIG. 3 shows a flowchart of operation according to the first embodiment.

FIG. 4 shows a flowchart of operation of a tracking process of objects according to a second embodiment.

### DETAILED DESCRIPTION OF THE INVENTION

### First Embodiment

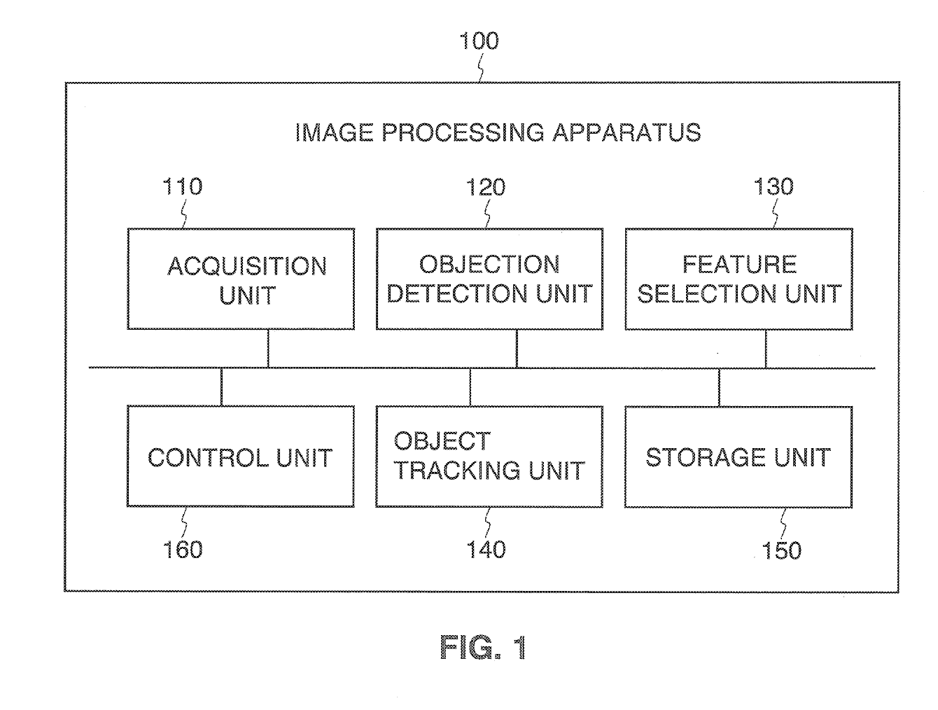

FIG. 1 shows a block diagram of an image processing apparatus 100 according to a first embodiment of the invention. The image processing apparatus includes an acquisition unit 110, an object detection unit 120, a feature selection unit 130, an object tracking unit 140, a storage unit 150, and a control unit 160. The acquisition unit 110 is connected to an image input device for capturing image to acquire the input image from the image input device. The object detection unit 120 detects an object included in input images using confidence value which represents object-likelihood described below. The feature selection unit 130 selects M (M is a positive integer smaller than N) feature extraction units from N feature extraction units such that separability between the confidence value of the object and that of background thereof become greater than a case where the N feature extraction units are used as described below. The object tracking unit 140 tracks the object using the M features extracted from the selected M (M is a positive integer smaller than N) feature extraction units.

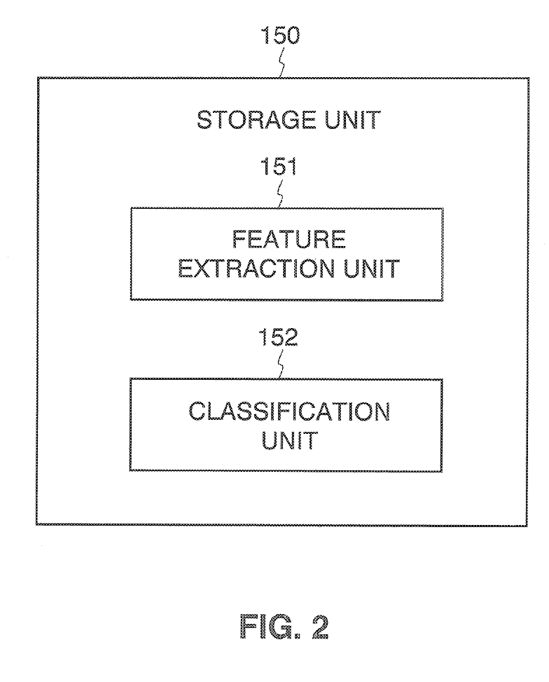

As shown in FIG. 2, the storage unit 150 stores N feature extraction units 151, a classification unit 152 having a classifier for classifying the object. The N feature extraction units 151 are pre-generated by learning the classifier. The classification unit 152 calculates confidence value which represents object-likelihood using the N features extracted from the N feature extraction units 151. The N feature extraction units 151 may be stored in the storage unit 150 or a storage unit arranged outside of the image processing apparatus 100. The control unit 160 controls each unit of the image processing apparatus 100. The object includes several types of objects such as people, animals and things and is not limited to particular objects.

The feature selection unit 130 may generate a plurality of groups of features, where each of the groups contains the extracted N features, based on a detection result of the object detection unit 120 or a tracking result of the object tracking unit 140. The feature selection unit 130 may select M feature extraction units from the N feature extraction units such that separability between the confidence value of the object and that of background thereof become greater, based on the generated plurality of groups of features.

Sequence of the images acquired by the acquisition unit 110 is input to the object detection unit 120 or the object tracking unit 140. The image processing apparatus 100 outputs a detection result of the object detection unit 120 and a tracking result of the object tracking unit 140 from the feature selection unit 130 or the object tracking unit 140. The object detection unit 120, the object tracking unit 140 and the feature selection unit 130 are connected to the storage unit 150 respectively. The object detection unit 120 outputs the detection result of the object to the object tracking unit 140 and the feature selection unit 130. The object tracking unit 140 outputs the tracking results of the object to the object detection unit 120 and the feature selection unit 130. The feature selection unit 130 outputs the selection result of the features to the object tracking unit 140.

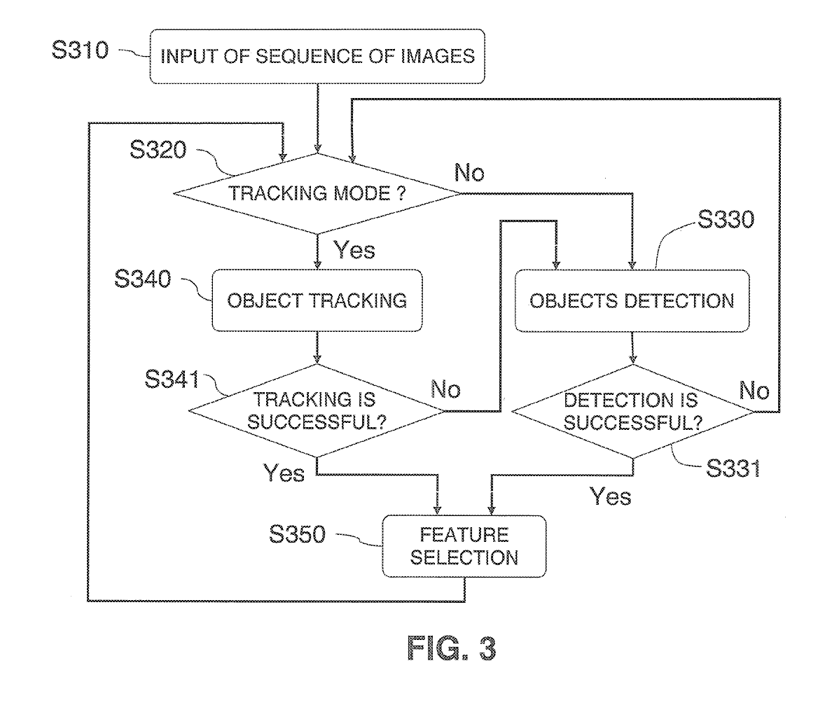

Operation of the image processing apparatus according to a first embodiment of the present invention is explained with reference to FIG. 3.

FIG. 3 is a flowchart of the operation of the image processing apparatus according to the first embodiment of the present invention.

In step S310, the control unit 160 stores image sequence acquired by the acquisition unit 110 in the storage unit 150.

In step S320, the control unit 160 determines whether the present mode is a tracking mode. For example, the control unit 160 determines that the present mode is the tracking mode in a case where detection and tracking of the object in the previous image are successful and feature selection is performed in step S350. When the control unit 160 determines that the present mode is the tracking mode (“Yes” in step S320), the control unit 160 proceeds to step S340. When the control unit 160 determines that the present mode is not the tracking mode. (“No” in step S320), the control unit 160 proceeds to step S330.

In step S330, the object detection unit 120 detects object using N features extracted by the N feature extraction units 151 (g₁, g₂, . . . , g_{N}) stored in the storage unit 150. More specifically, a confidence value which expresses object-likelihood with each position of an input image is calculated and the position having the peak of the confidence value is set to a position of the object. The confidence value c_{D} may be calculated based on the extracted N features x₁, x₂, . . . , x_{N} using the equation 1, where xi denotes the features extracted by the feature extraction unit gᵢ.

C_{D}=f_{D}(x₁, x₂, . . . , x_{N}) (Equation 1)

Function f_{D} is, for example, a classifier which separates pre-learned object for generating N feature extraction units from background thereof. Therefore, the function f_{D} may be nonlinear, but a linear function is simply used as shown in equation 2. Here “background” means areas after the removal of the object in an image. In fact, an area including positions of the input image is set to each position of the input image and classification is performed by extracting features from the set area to classify whether the position is an object. Therefore, the set areas include object and background thereof at the positions near the boundary of the object and background thereof. In such areas, the positions are classified as object when the proportion of the object is greater than a predefined value.

$${f}_{D} ( {x}_{1} , {x}_{2} , … , {x}_{N} ) = {\sum }_{i = 1}^{N} {a}_{i} {x}_{i} , \\ {a}_{i} ∈ R for i = 1 , … , N \qquad ( Equation 2 )$$

A classifier which satisfies the equation 2 may be realized by using, for example, well known AdaBoost algorithm where gᵢ denotes i-th weak classifier, xᵢ denotes output of the i-th weak classifier and aᵢ denotes weight of the i-th weak classifier, respectively.

In step S331, the control unit 160 determines whether detection of the object was successful. For example, the control unit 160 determines that detection is unsuccessful when the peak value of the confidence value is smaller than a threshold value. In step 331, the control unit 160 proceeds to step S320 when the control unit 160 determines that detection of the object is unsuccessful (“No” in step S331). The control unit 160 proceeds to step S350 when the control unit 160 determine that detection of the object is successful (“Yes” in step S331).

In step S340, the object tracking unit 140 tracks object using M features extracted by M feature extraction units selected by the feature selection unit 130. More specifically, confidence value which expresses object-likelihood at each position of the input image is calculated and the position having the peak of the confidence value is set to a position of the object. The object tracking unit 140 determines that detection is unsuccessful when the peak value of the confidence value is smaller than a threshold value. The confidence value c_{T} may be calculated based on the extracted M first features x_{σ1}, x_{σ2}, . . . , x_{σM} using the equation 3, where x_{σi} denotes the features extracted by the feature extraction unit g_{σi} given the conditions σ₁, σ₂, . . . , σ_{M}ε{1, 2, . . . , N} and σᵢ≠σⱼ if i≠j.

C_{T}=f_{T}(x_{σ}_{₁}, x_{σ}_{₂}, . . . , x_{σ}_{_{M}}) (Equation 3)

For example, function f_{T} limits input of the function f_{D} used for the detection of object to M features. If f_{D} is a linear function as shown in the equation 2, f_{T} can be expressed by the equation 4.

$${f}_{T} ( {x}_{{σ}_{1}} , {x}_{{σ}_{2}} , … , {x}_{{σ}_{M}} ) = {\sum }_{i = 1}^{M} {b}_{i} {x}_{σ} , \\ {b}_{i} ∈ R for i = 1 , … , M \qquad ( Equation 4 )$$

Simply, bi=a_{σi}(i=1, 2, . . . , M). Confidence value c_{T} is calculated by using similarity between M first features x_{σ1}, x_{σ2}, . . . , x_{σM} and M second features y_{σ1}, y_{σ2}, . . . , y_{σM} extracted from the object in the input image for which detection or tracking process is completed. For example, the similarity may be calculated by an inner product of a first vector having M first features and a second vector having M second features as shown in equation 5 where y_{σi} denotes the features extracted by the feature extraction unit g_{σi}.

$${c}_{T} = \frac{1}{M} {\sum }_{i = 1}^{M} {y}_{{σ}_{i}} {x}_{{σ}_{i}} \qquad ( Equation 5 )$$

The equation 6, which uses positive values of the product part of the equation 5, may also be used.

$${c}_{T} = \frac{1}{M} {\sum }_{i = 1}^{M} h ( {y}_{{σ}_{i}} {x}_{{σ}_{i}} ) , \\ h ( x ) = \{ \begin{matrix}x & x > 0 \\ 0 & otherwise\end{matrix} \qquad ( Equations 6 )$$

The equation 7, which focuses on the sign of the product part of the equation 5, may also be used.

$${c}_{T} = \frac{1}{M} {\sum }_{i = 1}^{M} h ( sgn ( {y}_{{σ}_{i}} {x}_{{σ}_{i}} ) ) , \\ sgn ( x ) = \{ \begin{matrix}1 & x > 0 \\ - 1 & otherwise\end{matrix} \qquad ( Equation 7 )$$

The function h(x) is the same as that used in the equation 6. The equation 7 represents a matching rate between signs of M first features and ones of M second features.

In step S341, the control unit 160 determines whether the tracking of the objects is successful. The control unit 160 proceeds to step S350 when the control unit 160 determine that tracking of the objects is successful (“Yes” in step S341). The control unit 160 proceeds to step S330 when the control unit 160 determine that tracking of the objects is unsuccessful (“No” in step S341).

In step S350, the feature selection unit 130 selects M feature extraction units from N feature extraction units such that degree in separation of the confidence value c_{D} which represents object-likelihood between the object and background thereof becomes larger, in order to adapt to change of appearances of the object and background thereof. The output of the unselected N-M feature extraction units is treated as 0 in the calculation of c_{D}. Suppose that the calculating method of c_{D} is performed by the equation 2 in a feature selection method, features y₁, y₂, . . . , y_{N} (yᵢ denotes features extracted by gᵢ) are extracted as a group from the positions of the objects by N feature extraction units and M feature extraction units are selected in descending order of ai*yi. Instead of using the N features as they are, N features extracted as other group from the position of the objects in each image, which has plurality of processed objects, may be considered. This enable us to calculate the average value Myᵢ of features extracted by each feature extraction unit gᵢ, and select M feature extraction units in descending order of aᵢ*yᵢ or incorporate higher-order statistics. For example, letting syᵢ be a standard deviation of features extracted by feature extraction unit gᵢ, M feature extraction units are selected in descending order of aᵢ*(yᵢ−syᵢ) or aᵢ*(Myᵢ−syᵢ). N features z₁, z₂, . . . , z_{N} (zᵢ denotes feature extracted by feature extraction unit gᵢ) extracted from neighboring areas of the objects by N feature extraction units may be used to select M feature extraction units in descending order of aᵢ*(yᵢ−zᵢ). As for the feature zᵢ extracted from the background, M feature extraction units are selected in descending order of aᵢ*(yᵢ−Mzᵢ) or aᵢ*(Myᵢ−Mzᵢ) where M_{z1}, M_{z2}, . . . , M_{zN} are average values of features extracted from the neighboring areas of the objects and background positions without objects in a plurality of pre-processed images instead of using the values of the feature zᵢ as it is. Higher-order statistics such as a standard deviation sz₁, sz₂, . . . , sz_{N} as well as the average values may be incorporated. For example, M feature extraction units may be selected in descending order of aᵢ*(Myᵢ−syᵢ−Mzᵢ−szᵢ). The neighboring areas for extracting zi may be selected from, for example, four areas (e.g., right, left, top and bottom) of the objects, or areas which have a large c_{D} or c_{T}. The area having a large c_{D} is likely to be falsely detected as the objects and the area having a large c_{T} is likely to be falsely tracked as the objects. The selection of this area widens the gap between c_{T} at this area and c_{T} at the position of the objects, and therefore the peak of c_{T} may be sharpened. Feature extraction units, which corresponds to aᵢ*yᵢ greater than a threshold value, may be selected instead of selecting M feature extraction units in descending order of aᵢ*yᵢ. If the number of aᵢ* yᵢ greater than a predefined threshold value is smaller than M, which is set to the number of minimally selected feature extraction units, M feature extraction units may be selected in descending order of aᵢ*yᵢ.

Images of multiple resolutions may be input by creating low-resolution images after down sampling input images. At this time, the object detection unit 120 and the object tracking unit 140 perform detection or tracking for the images of multiple resolutions. Detection of the objects is performed by setting the position, which has the maximum value of the peak value of c_{D} in each image resolution, as the position of the objects. Although the generation method of the samples in the feature selection unit 130 is as mentioned above fundamentally; however, the neighboring areas of the objects differ in that they also exist on images having different resolutions as well as the images having the same resolution as the resolution where peak value of c_{D} or c_{T} shows the maximum value. Therefore, samples used for feature selection are created from images of multiple resolutions.

According to the first embodiment of the image processing apparatus, M feature extraction units are selected from pre-generated N feature extraction units such that separability between the confidence value of the objects and that of background thereof become greater. As a result, a high speed tracking as well as adaptation to appearance changes of the objects and background thereof can be realized.

### Second Embodiment

In this embodiment, a verification process for candidate positions of the objects is introduced in a case where the confidence value c_{T}, which represents object-likelihood, has a plurality of peaks (i.e., there are plurality of candidate positions of the objects).

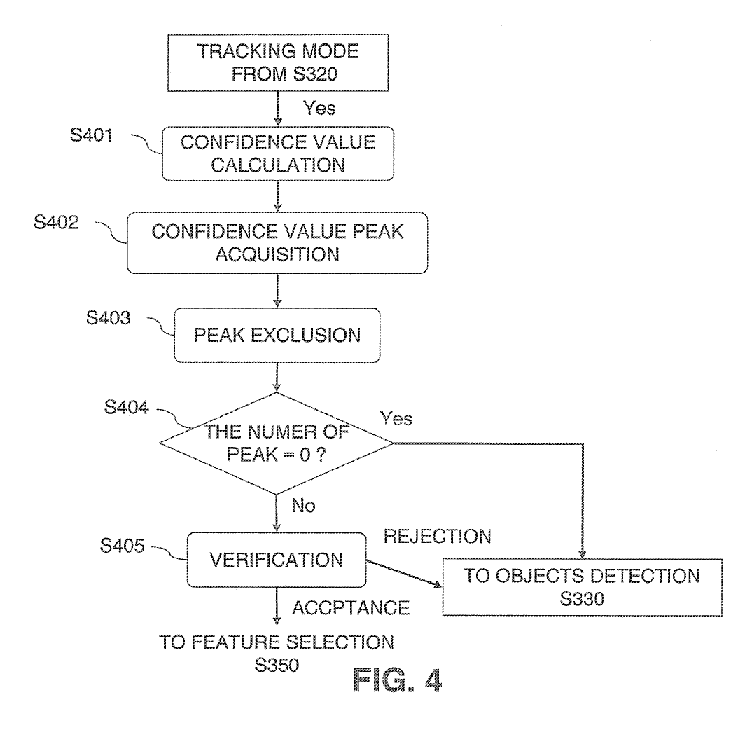

The block diagram of an image processing apparatus according to a second embodiment of the invention is the same as that of the first embodiment of the invention as shown in FIG. 1, and therefore its explanation is omitted. Operation of the image processing apparatus according to a second embodiment of the present invention is schematically the same as that according to the first embodiment of the present invention as shown in the flowchart of FIG. 3. This second embodiment differs from the first embodiment in terms of tracking steps S340 and S341 of the objects, and therefore a flowchart of this tracking step will be explained with respect to FIG. 4.

In step S401, the object tracking unit 140 calculates confidence value c_{T}, which represents object-likelihood as shown in equation 3, at positions of each image using, for example, one of equations 4-7, when the object tracking unit 140 determines that the present mode is a tracking mode in step S320 where the object tracking unit 140 determines whether the present mode is the tracking mode.

In step S402, the object tracking unit 140 acquires the peak of the confidence value c_{T} calculated in step S401.

In step S403, the object tracking unit 140 excludes the peak if the peak value acquired in step S402 is smaller than a threshold value.

In step S404, the control unit 160 determines whether the number of the remaining peaks is 0. The control unit 160 proceeds to step S330 where detection of the objects is performed again, when the control unit 160 determines that the number of the remaining peaks is 0 (“Yes” in step S404) and tracking is unsuccessful. The control unit 160 proceeds to step S405 when the control unit 160 determines that the number of the remaining peaks is not 0 (i.e., the number of the remaining peaks is greater than or equal to) (“Yes” in step S404) and tracking is unsuccessful.

In step S405, the control unit 160 verifies a hypothesis that each of the remaining peak positions corresponds to the position of the objects. The verification of the hypothesis is performed to calculate confidence value c_{V} which represents object-likelihood. If the confidence value is equal to or smaller than a threshold value, the corresponding hypothesis is rejected. If the confidence value is greater than a threshold value, the corresponding hypothesis is accepted. The control unit 160 proceeds to step S330 where detection of the objects is performed again, when the control unit 160 determines that all of the hypotheses are rejected and tracking is unsuccessful. The control unit 160 sets the peak position, which has the maximum value of c_{V}, as the final position of the objects and proceeds to the feature selection step S350, when there are a plurality of adapted hypotheses.

The confidence value c_{V} showing object-likelihood used for hypothetical verification is calculated by means other than means for calculating c_{T}. c_{D} may be used as c_{V} in the simplest way. The hypothesis of the position, which is not like objects, can be rejected. Outputs of the classifiers using higher level feature extraction units, which are different from the feature extraction units stored in the storage unit 150, may be used as cᵥ. In general, the high level feature extraction units have a large calculation cost, but the number of calculations of c_{V} for an input image is smaller than that of c_{D} and c_{T}. Therefore, the calculation cost does not affect the entire processing time of the apparatus so much. As the high level feature extraction, for example, features based on edges may be used as described in N. Dalal and B. Triggs, “Histograms of Oriented Gradients for Human Detection,” Computer Vision and Pattern Recognition, 2005. Similarity between the position of the object in the previous image and the hypothetical position in the present image may be used. This similarity may be normalized correlation between pixel values in two regions, where each of the regions includes the position of the object and the hypothetical position or may be similarity of the distribution of pixel values. The similarity of the distribution of pixel values may be based on, for example, Bhattacharrya coefficient or sum of intersection of two histograms of pixel values.

According to the second embodiment of the image processing apparatus, a more robust tracking may be realized by introducing a verification process in the tracking process of the objects.

### Third Embodiment

In this embodiment, a plurality of objects are included in an image as explained below. The block diagram and operation of the image processing apparatus according to a third embodiment of the present invention is similar to those according to the first embodiment of the present invention as shown in the block diagram of FIG. 1 and the flowchart of FIG. 3. A flowchart of this embodiment will be explained with respect to FIG. 3.

In step S310, the control unit 160 stores sequence of images input from an image input unit to an storage unit.

In step S320, the control unit 160 determines whether the present mode is a tracking mode. For example, the control unit 160 determines that the present mode is the tracking mode in a case where detection and tracking of the object in the previous image are successful and feature selection is performed for at least one object in step S350. When a certain number of images are processed after the last time the detection step S330 is performed, the control unit 160 determines that the present mode is not the tracking mode.

In step S330, the object detection unit 120 detects objects using N features extracted by the N feature extraction units g₁, g₂, . . . , g_{N} stored in the storage unit 150. More specifically, a confidence value c_{D} which expresses object-likelihood with each position of an input image is calculated and all of the positions having the peak of the confidence value are acquired and each of the positions is set to a position of the object.

In step S331, the control unit 160 determines whether detection of the objects was successful. For example, the control unit 160 determines that detection is unsuccessful when all of the peak values of the confidence values are smaller than a threshold value. In this case, the confidence value c_{D} is calculated by, for example, the equation 2. In step 331, the control unit 160 proceeds to step S320 and processes the next image when the control unit 160 determines that detection of the object is unsuccessful (“No” in step S331). The control unit 160 proceeds to step S350 when the control unit 160 determine that detection of the object is successful (“Yes” in step S331).

In step S340, the object tracking unit 140 tracks each of the objects using M features extracted by M feature extraction units selected for each object by the feature selection unit 130. More specifically, confidence value c_{T} which expresses object-likelihood at each position of the input image is calculated for each object and the position having the peak of the confidence value is set to a position of the object.

In step S341, the control unit 160 determines whether the tracking of the objects is successful. The control unit 160 determines that tracking is unsuccessful when the peak values of the confidence values for all of the objects are smaller than a threshold value (“No” in step S341). The control unit 160 may determine that tracking is unsuccessful when the peak values of the confidence values for at least one objects are smaller than a threshold value (“No” in step S341). In this case, the confidence value c_{T} is calculated by, for example, the equation 4. The control unit 160 proceeds to step S350 when the control unit 160 determines that tracking of the object is successful (“Yes” in step S341). The control unit 160 proceeds to step S330 when the control unit 160 determine that tracking of the object is unsuccessful (“No” in step S341).

In step S350, the feature selection unit 130 selects M feature extraction units from. N feature extraction units for each object such that degree in separation of the confidence value c_{D} which represents object-likelihood between each of the objects and background thereof, in order to adapt to change of appearances of each of the objects and background thereof. Since the calculating method of c_{D} is explained in the first embodiment of the present invention, explanation for the calculating method is omitted.

According to the third embodiment of the image processing apparatus, tracking may be more robust and faster than ever before when a plurality of objects are included in an image.

### Other Embodiments

Before calculating the equation 5, the equation 6 and the equation 7, which are calculating means for the confidence value c_{T} representing object-likelihood, a certain value θ_{σi} may be subtracted from the output of each feature extraction unit g_{σi}. This means that x_{σi} and y_{σi} of the equation 5, the equation 6 and the equation 7 are replaced with x_{σi}·θ_{σi} and y_{σi}−θ_{σi}, respectively. θ_{σi} may be, for example, the average value My_{σi} of y_{σi} used in the above-mentioned feature selection, the average value of both y_{σi} and z_{σi}, or the intermediate value instead of the average value. Learning result of classifiers, which separates y_{σi} and z_{σi} (a plurality of y_{σi} and z_{σi} exist if there are a plurality of samples generated at the time of feature selection), may be used for each output of each feature extraction units gᵢ. For example, linear classifiers, which is expressed in the form of l=ux·v (l denotes a category label, x denotes values of the learning sample (i.e., y_{σi} or z_{σi}), and u and v denote the constants determined by learning). The category label of y_{σi} is set to 1 and the category label of z_{σi} is set to −1 at the time of learning. If the value of u, which is acquired by the learning result, is not 0, v/u is used as θᵢ=0. If the value of u, which is acquired by the learning result, is 0, then θᵢ=0. Learning of classifiers is performed using linear discriminant analysis, support vector machines and any other methods which are capable of learning linear classifiers.

The invention is not limited to the above embodiments, but elements can be modified and embodied without departing from the scope of the invention. Further, the suitable combination of the plurality of elements disclosed in the above embodiments may create various inventions. For example, some of the elements can be omitted from all the elements described in the embodiments. Further, the elements according to different embodiments may be suitably combined with each other. The processing step of each element of the image processing apparatus may be performed by a computer using a computer-readable image processing program stored or transmitted in the computer.

What is claimed is:

1. An image processing apparatus, comprising:
a classification unit configured to extract N features from an input image using pre-generated N feature extraction units and calculate confidence value which represents object-likelihood based on the extracted N features;
an object detection unit configured to detect an object included in the input image based on the confidence value;
a feature selection unit configured to select M feature extraction units from the N feature extraction units such that separability between the confidence value of the object and that of background thereof becomes greater than a case where the N feature extraction units are used, the M being a positive integer smaller than N; and
an object tracking unit configured to extract M features from the input image and tracks the object using the M features selected by the feature selection unit.

2. The apparatus of claim 1, wherein the object detection unit calculates the confidence value based on the extracted M features and tracks the object based on the calculated confidence value.

3. The apparatus of claim 1, wherein the object tracking unit calculates the confidence value based on a similarity between a first vector which includes M first features extracted from a position of the object in the input image and a second vector which includes M second features extracted from a position of the object in the input image for which detection of the object detection unit or tracking of the object tracking unit is completed.

4. The apparatus of claim 3, wherein the similarity is calculated by a rate where a sign of each component of the first vector is equal to a sign of each corresponding component of the second vector.

5. The apparatus of claim 2, further comprising a control unit configured to calculate the confidence value at each position of the input image and determine that a peak of the confidence value is a position of the object.

6. The apparatus of claim 5, wherein the control unit determines that detection of the object is unsuccessful when a value at the peak of the confidence value is smaller than a threshold value.

7. The apparatus of claim 5, wherein the control unit calculates the confidence value at each position of the input image and determines that a peak of the confidence value is a position of the object to be tracked.

8. The apparatus of claim 7, wherein the control unit determines that tracking of the object is unsuccessful when a value at the peak of the confidence value is smaller than a threshold value and detects the object by the object detection unit again.

9. The apparatus of claim 1, wherein the feature selection unit generates a plurality of groups of features, where each of the groups contains the extracted N features, based on a detection result of the object detection unit or a tracking result of the object tracking unit and selects M feature extraction units from the N feature extraction units such that separability between the confidence value of the object and that of background thereof becomes greater.

10. The apparatus of claim 9, wherein the feature selection unit generates a plurality of groups of features, where each of the groups contains the extracted N features, from a neighboring area of the detected or tracked object and generates a plurality of groups of features, where each of the groups contains the extracted N features, from a neighboring area of the object.

11. The apparatus of claim 10, wherein the feature selection unit selects M feature extraction units from the N feature extraction units such that separability between the confidence value of the object and that of the neighboring area becomes greater.

12. The apparatus of claim 9, wherein the feature selection unit stores, as a history, the features of the plurality of groups generated in one or more images, where detection or tracking of the object is completed, and positions of the features of the plurality of groups on the images.

13. The apparatus of claim 12, wherein the feature selection unit selects M feature extraction units from the N feature extraction units such that separability between the object and the background thereof becomes greater based on the history.

14. A computer-implemented image processing method, comprising:
extracting N features from an input image using pre-generated N feature extraction units and calculating confidence value which represents object-likelihood based on the extracted N features;
detecting an object included in the input image based on the confidence value;
selecting M feature extraction units from the N feature extraction units such that separability between the confidence value of the object and that of background thereof becomes greater than a case where the N feature extraction units are used, the M being a positive integer smaller than N; and
extracting M features from the input image and tracking the object using the selected M features.

15. An image processing program stored in a computer readable storage medium for causing a computer to implement a instruction, the instruction comprising:
extracting N features from an input image using pre-generated N feature extraction units and calculating confidence value which represents object-likelihood based on the extracted N features;
detecting an object included in the input image based on the confidence value;
selecting M feature extraction units from the N feature extraction units such that separability between the confidence value of the object and that of background thereof becomes greater than a case where the N feature extraction units are used, the M being a positive integer smaller than N; and
extracting M features from the input image and tracking the object using the selected M features.
